(19) United States
(12) Patent Application Publication
(10) Pub. No.: US 2023/0089972 A1
(43) Pub. Date: Mar. 23, 2023

(54) Metal Pole Plate Sealing Structure for Fuel Cell and Fuel Cell Using Same

(71) Applicant: Robert Bosch GmbH, Stuttgart (DE)

(72) Inventors: Guoqing Hu, Wuxi (CN); Xu Zhang, Shanghai (CN); Xu Xie, Shanghai (CN); Youfu Xie, Wuxi (CN)

(21) Appl. No.: 17/944,556

(22) Filed: Sep. 14, 2022

(30) Foreign Application Priority Data
Sep. 23, 2021 (CN) 202122298256.3

(51) Int. Cl. H01M 8/0286; H01M 8/0284; H01M 8/1004; H01M 8/0273; H01M 8/0276

(52) U.S. Cl. CPC H01M 8/0286; H01M 8/0284; H01M 8/1004; H01M 8/0273; H01M 8/0276

(57) ABSTRACT

A metal pole plate sealing structure for a fuel cell is disclosed, as well as a fuel cell using this structure. The metal pole plate sealing structure for a fuel cell includes a metal pole plate, a membrane electrode assembly and a sealing rubber body. The metal pole plate has a sealing rubber groove. The sealing rubber body is accommodated in the sealing rubber groove. The sealing rubber groove, the sealing rubber body and a frame of the membrane electrode assembly cooperate with each other to seal an internal space enclosed when the metal pole plate and the membrane electrode assembly are pressed together. An inner surface of the sealing rubber groove has a positioning unit which makes it easier to fix an installation position of the sealing rubber body in the sealing rubber groove.

This application claims priority under 35 U.S.C. § 119 to patent application no. CN 202122298256.3, filed on Sep. 23, 2021 in China, the disclosure of which is incorporated herein by reference in its entirety.

The present disclosure relates to the technical field of fuel cells, in particular to a metal pole plate sealing structure for a fuel cell, and fuel cell using this structure.

### BACKGROUND

In the assembly process of fuel cells, it is imperative that the gas flow field be sealed to avoid leakage of reaction gases from inside the field. As shown in FIG. 1, in the prior art, sealing rubber 30 is generally used to isolate the inside of the flow field from the outside. The sealing rubber 30 is attached to metal pole plates 10, and when the fuel cell is being assembled, an external force is applied so that the metal pole plates 10 at the two sides are pressed tightly towards a membrane electrode assembly 20, and under the action of the assembly force there is sufficient contact force between the sealing rubber 30 and the metal pole plates 10 and between the sealing rubber and the membrane electrode assembly 20. In this way, the sealing function can be achieved.

In an ideal state, the width of the sealing rubber 30 is generally less than the width of a sealing rubber groove 11 for accommodating the sealing rubber 30 in the metal pole plate 10. This is because a rubber material is used for the sealing rubber 30; during assembly, pressure will cause the rubber to experience elastic deformation, and if the width of the sealing rubber 30 were the same as that of the sealing rubber groove 11, some of the material might be squeezed out of the groove when the sealing rubber 30 is compressed, and the sealing performance might be affected. However, when the width of the sealing rubber 30 is less than the width of the bottom of the sealing rubber groove 11, it is very difficult to match a centre line of the sealing rubber 30 with a groove centre line of the metal pole plate 10 when the sealing rubber 30 is attached to the metal pole plate 10, so alignment of anode sealing rubber and cathode sealing rubber is very difficult. There are two reasons: (1) the sealing rubber groove 11 is produced by stamping, and the cross section thereof is trapezoidal with rounded corners, not rectangular. The groove centre line is very difficult to measure in an actual plate. (2) During assembly, it is very difficult to detect misalignment of the sealing rubber 30 at each position. Thus, misalignment of the sealing rubber 30 at the positive and negative poles often occurs. Referring to FIG. 2, if the misalignment is too great, sealing performance might be reduced, and it may even be impossible to realize the sealing function.

### SUMMARY

The present disclosure relates to a metal pole plate sealing structure for a fuel cell, and a fuel cell using this structure, which are capable of solving the problems in the prior art.

To this end, according to one aspect of the present disclosure, a metal pole plate sealing structure for a fuel cell is disclosed, comprising a metal pole plate, a membrane electrode assembly and a sealing rubber body, the metal pole plate having a sealing rubber groove, and the sealing rubber body being accommodated in the sealing rubber groove; the sealing rubber groove, the sealing rubber body and a frame of the membrane electrode assembly cooperate with each other to seal an internal space enclosed when the metal pole plate and the membrane electrode assembly are pressed together, wherein an inner surface of the sealing rubber groove has a positioning unit which makes it easier to fix an installation position of the sealing rubber body in the sealing rubber groove.

According to an exemplary embodiment of the present disclosure, the positioning unit is formed at the bottom of the sealing rubber groove.

According to an exemplary embodiment of the present disclosure, the height of the positioning unit is ⅕ of the height of the sealing rubber body.

According to an exemplary embodiment of the present disclosure, the positioning unit is a protrusion extending from the bottom of the sealing rubber groove towards the top, the protrusion being formed by stamping the metal pole plate.

According to an exemplary embodiment of the present disclosure, the sealing rubber groove has an isosceles trapezoidal cross section in the thickness direction of the metal pole plate, and the junction of the bottom and a sidewall of the sealing rubber groove is separated from the positioning unit by a gap.

According to an exemplary embodiment of the present disclosure, the sealing rubber groove is arranged around the periphery of the metal pole plate and the peripheries of gas inlet and outlet holes at two ends of the metal pole plate.

According to an exemplary embodiment of the present disclosure, the positioning units are disposed at two sides in the width direction of the sealing rubber body, and are separated by a gap that is larger than the width of the sealing rubber body.

According to an exemplary embodiment of the present disclosure, the metal pole plate is a bipolar plate.

According to an exemplary embodiment of the present disclosure, the sealing rubber body has a rectangular cross section in the thickness direction of the metal pole plate.

According to another aspect of the present disclosure, a fuel cell is disclosed, using the metal pole plate sealing structure as described above.

To gain further understanding of the features and technical content of the present disclosure, please refer to the following detailed description of the present disclosure and the drawings. However, the drawings are merely for reference and illustration, and are not intended to limit the present disclosure.

### BRIEF DESCRIPTION OF THE DRAWINGS

A more complete understanding of the abovementioned and other aspects of the present disclosure will be gained through the following detailed description which refers to the drawings, in which:

FIG. 1 is a structural schematic drawing of the assembly positions of sealing rubber bodies in an ideal state, using the prior art.

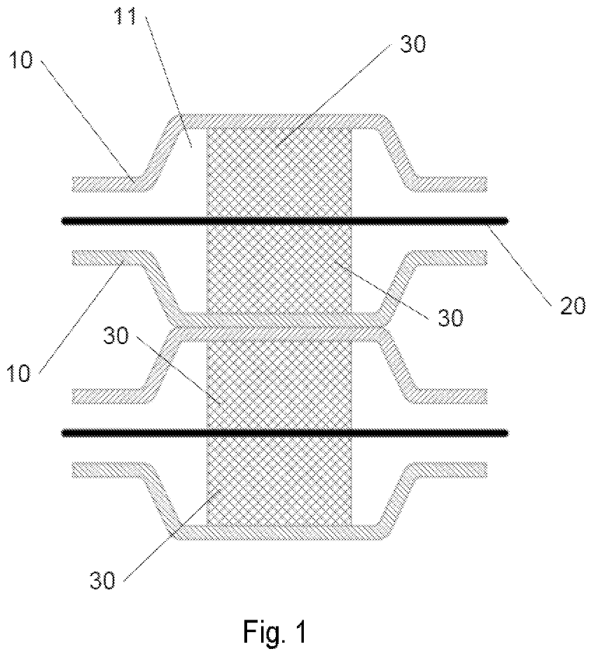

FIG. 2 is a structural schematic drawing of sealing rubber bodies assembled in misalignment, using the prior art.

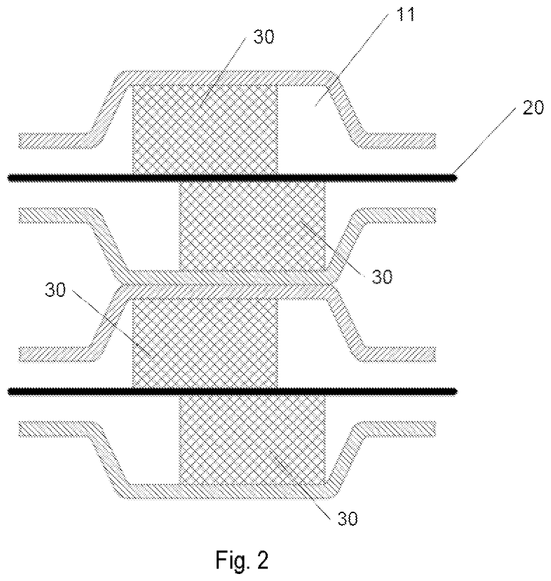

FIG. 3 is a structural schematic drawing of sealing rubber body assembly according to an embodiment of the present disclosure.

### DETAILED DESCRIPTION

To help those skilled in the art to gain a precise understanding of the subject matter the present disclosure, particular embodiments of the present disclosure are described in detail below with reference to the drawings.

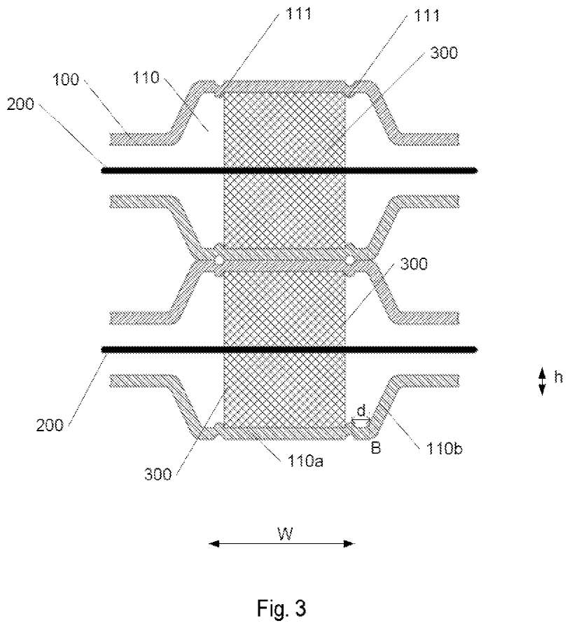

Referring to FIG. 3, a metal pole plate sealing structure for a fuel cell comprises a metal pole plate 100, a membrane electrode assembly 200 and a sealing rubber body 300. It will be understood that to highlight the key technical features of the present disclosure, a complete drawing of the metal pole plate and membrane electrode assembly is not provided in FIG. 3, which instead merely provides a schematic drawing of the metal pole plate and membrane electrode assembly close to a frame part of the membrane electrode assembly.

The metal pole plate 100 has a sealing rubber groove 110, and the sealing rubber body 300 is accommodated and fixed in the sealing rubber groove 110. The sealing rubber groove 110, the sealing rubber body 300 and the frame of the membrane electrode assembly 200 cooperate with each other to seal an internal space enclosed when the metal pole plate 100 and the membrane electrode assembly 200 are pressed together. An inner surface of the sealing rubber groove 110 has a positioning unit 111 which makes it easier to fix the position of the sealing rubber body 300 in the sealing rubber groove 110 in a horizontal direction (i.e. the width direction W of the sealing rubber body 300). Once the position of the sealing rubber body 300 is fixed, the sealing rubber body 300 is generally further fixed to the sealing rubber groove by means of a bottom adhesive. Thus, the fixed sealing rubber body 300 hermetically separates its own two sides in the horizontal direction.

In this particular embodiment, the positioning unit 111 is formed at the bottom of the sealing rubber groove 110. It will be understood that in other embodiments, the position of the positioning unit 111 is not limited to being at the bottom of the sealing rubber groove 110; it may also be located at other positions, such as a sidewall of the sealing rubber groove 110, as long as it can abut the sealing rubber body 300, to ensure that no deviation occurs in the approximate position thereof in the width direction W of the sealing rubber body 300.

For ease of implementation from a process point of view, the positioning unit 111 may be a protrusion extending from the bottom of the sealing rubber groove 110 towards the top, the protrusion being formed by subjecting the metal pole plate 100 to a stamping process. The applicant has discovered that the height of the positioning unit 111 formed by stamping is about ⅕ of the height of the sealing rubber body 300, and has high stability and a low cost.

As shown in FIG. 3, the sealing rubber groove 110 has an isosceles trapezoidal cross section in the thickness direction of the metal pole plate 100. Similarly, to ensure the stability of the protrusion formed by stamping, the junction B of the bottom 110a and a sidewall 110b of the sealing rubber groove 110 is separated from the positioning unit 111 by a gap d.

To ensure the sealing result, the sealing rubber groove 110 is arranged around the periphery of the metal pole plate 100 and the peripheries of gas inlet and outlet holes (not shown) at two ends of the metal pole plate 100.

When assembling the cell, taking into account the deformation of the sealing rubber body 300 caused by the metal pole plate 100 applying pressure in the direction of the membrane electrode assembly 200, the positioning units 111 are disposed at two sides in the width direction W of the sealing rubber body, and are separated by a gap that is slightly larger than the width of the sealing rubber body 300. Thus, when the sealing rubber body 300 is compressed, it will not suffer misalignment and hence impaired sealing performance due to deformation. As shown in the figure, in this particular embodiment, the sealing rubber body 300 has a rectangular cross section in the thickness direction h of the metal pole plate 100. In other embodiments, the cross section of the sealing rubber body 300 might also be another shape depending on needs.

It will be understood that when the present disclosure is used for a stack of fuel cells, the metal pole plate 100 may be a bipolar plate. A single fuel cell or a fuel cell stack using the metal pole plate sealing structure as described above can achieve the abovementioned sealing result.

Although the present disclosure has been shown and described based on specific embodiments, it is not limited to the details shown. On the contrary, various details of the present disclosure can be modified within the scope of the claims and their equivalent substitutes.

What is claimed is:

1. A metal pole plate sealing structure for a fuel cell, comprising:
a metal pole plate having a sealing rubber groove;
a membrane electrode assembly having a frame; and
a sealing rubber body that is accommodated in the sealing rubber groove,
wherein the sealing rubber groove, the sealing rubber body and the frame cooperate with each other to seal an internal space enclosed when the metal pole plate and the membrane electrode assembly are pressed together, and
wherein an inner surface of the sealing rubber groove has a positioning unit configured to fix an installation position of the sealing rubber body in the sealing rubber groove.

2. The sealing structure as claimed in claim 1, wherein the positioning unit is formed at the bottom of the sealing rubber groove.

3. The sealing structure as claimed in claim 2, wherein the height of the positioning unit is ⅕ of the height of the sealing rubber body.

4. The sealing structure as claimed in claim 2, wherein the positioning unit includes a protrusion extending from the bottom of the sealing rubber groove towards the top, the protrusion being formed by stamping the metal pole plate.

5. The sealing structure as claimed in claim 4, wherein the sealing rubber groove has an isosceles trapezoidal cross section in the thickness direction of the metal pole plate, and a junction of a bottom and a sidewall of the sealing rubber groove is separated from the positioning unit by a gap.

6. The sealing structure as claimed in claim 1, wherein:
the metal pole plate defines a gas inlet hole and a gas outlet hole, and
the sealing rubber groove is arranged around the periphery of the metal pole plate and the peripheries of the gas inlet and the gas outlet hole.

7. The sealing structure as claimed in claim 1, wherein:
the positioning unit includes a first protrusion and a second protrusion,
the first protrusion and the second protrusion are disposed at two sides in the width direction of the sealing rubber body, and are separated by a gap that is larger than the width of the sealing rubber body.

8. The sealing structure as claimed in claim 1, wherein the metal pole plate is a bipolar plate.

9. The sealing structure as claimed in claim 1, wherein the sealing rubber body has a rectangular cross section in the thickness direction of the metal pole plate.

10. A fuel cell comprising the metal pole plate sealing structure as claimed in claim 1.
